(19) United States
(12) Patent Application Publication
(10) Pub. No.: US 2026/0122187 A1
(43) Pub. Date: Apr. 30, 2026

(54) CHARGING METHOD AND DEVICE

(71) Applicant: HUAWEI TECHNOLOGIES CO., LTD., Shenzhen (CN)

(72) Inventors: Xiaoqing Zheng, Shanghai (CN); Weijun Xing, Shanghai (CN); Wei Wang, Kista (SE)

(21) Appl. No.: 19/432,306

(22) Filed: Dec. 24, 2025

Related U.S. Application Data
(63) Continuation of application No. PCT/CN2023/105307, filed on Jun. 30, 2023.

(51) Int. Cl. H04M 15/00; H04W 72/04

(52) U.S. Cl. CPC H04M 15/66; H04W 72/04

(57) ABSTRACT

A charging method and a device are provided. In the method, a first control node receives a first request for requesting to allocate a resource. The first control node obtains a charging policy and charging information, where the charging policy includes a charging policy corresponding to at least one charging type, the charging information includes charging information corresponding to the at least one charging type, and the charging type includes one or more of the following types: a functional type, a value type, a resource type, and a scenario-based type. The first control node sends the charging policy and the charging information to at least one execution node, to cause the at least one execution node to report resource utilization information based on the charging policy and the charging information.

### CROSS-REFERENCE TO RELATED APPLICATIONS

This is a continuation of International Patent Application No. PCT/CN2023/105307, filed on Jun. 30, 2023, the disclosure of which is hereby incorporated by reference in its entirety.

### TECHNICAL FIELD

This application relates to the field of wireless communication, and in particular, to a charging method and a device.

### BACKGROUND

A conventional mobile communication network mainly provides services such as traffic, call, and short message services for users. Therefore, a charging function is mainly used to report the traffic, the call, and the short message services based on traffic, call duration, and an event, to implement credit control on the users.

With the development of a mobile communication technology, a mobile communication network may provide a new data service for the users. For example, a future mobile communication network (for example, 6G) may further have multi-dimensional new capabilities such as a computing capability, an AI capability, and a sensing capability. Optionally, for a more open and diversified mobile communication network in the future, a third party similar to an integrator may also be introduced, and a plurality of parties have different charging requirements in different security domains.

Consequently, a current charging mode cannot support charging requirements of new services and new capabilities of the mobile communication network.

### SUMMARY

This application provides a charging method and a device, to implement convergent charging integrating a plurality of charging types.

According to a first aspect, an embodiment of this application provides a charging method, including: A first control node receives a first request, where the first request is for requesting to allocate a resource. The first control node obtains a charging policy and charging information, where the charging policy includes a charging policy corresponding to at least one charging type, the charging information includes charging information corresponding to the at least one charging type, and the charging type includes one or more of the following types: a functional type, a value type, a resource type, and a scenario-based type. The first control node sends a charging rule to at least one execution node, where the charging rule includes the charging policy and the charging information, or the charging rule is generated based on the charging policy and the charging information, to cause the at least one execution node to report resource utilization information according to the charging rule, and the at least one execution node is an execution node that is configured to provide a resource and that is allocated by the first control node.

In the charging method provided in embodiments of this application, a single charging policy and single charging information are not used, and different charging policies and charging information may be used for different charging types. For example, for a mobile communication network, charging policies and charging information may be respectively configured for traffic, duration, an event, and a task based on a functional type; or charging policies and charging information may be respectively configured for a computing resource, a storage resource, an AI model resource, an algorithm resource, a data resource, an image resource, a software package resource, and a code resource based on a resource type; or charging policies and charging information may be respectively configured for high-precision positioning, game acceleration, video decoding, video acceleration, and in-band flow computing based on a scenario, to meet diversified charging requirements on different services, so as to meet a charging requirement of a new service and a new capability.

In a possible implementation, the method further includes: The first control node sends the charging rule to a second control node, where the first control node is a control node in a first charging domain, and the second control node is a control node in a second charging domain.

In this implementation, for the mobile communication network, convergent charging integrating a plurality of charging domains may be further implemented. In other words, a charging policy and charging information can be shared in the plurality of charging domains, so that in a charging domain, charging can be performed based on a charging policy and charging information of the charging domain and a charging policy and charging information of another charging domain, thereby meeting a convergent charging requirement in an emerging and future multi-domain communication scenario.

In a possible implementation, the method further includes: The first control node sends indication information to a first execution node, where the first execution node is an execution node that is in a first charging domain and that is of the at least one execution node, and the indication information indicates the at least one first execution node to send the resource utilization information to a second execution node in a second charging domain.

In a scenario of convergent charging integrating a plurality of charging domains, resource utilization information of a user may be shared in the plurality of charging domains. For example, an execution node in a charging domain may send the resource utilization information to an execution node in another charging domain, and the foregoing process may be triggered and performed by a control node, to cause the execution node in the another charging domain to report the resource utilization information.

In a possible implementation, the obtaining, by the first control node, the charging policy and the charging information includes:

The first control node obtains the charging policy from a first policy node, and the first control node obtains the charging information from a first charging node. Alternatively, the first control node obtains the charging policy and the charging information from a first charging node.

In this embodiment of this application, the first control node may obtain the charging policy from a policy node, and obtain the charging information from a charging node; or may obtain the charging policy and the charging information from a charging node. This implementation helps simplify execution steps of a control node.

In a possible implementation, the obtaining, by the first control node, the charging policy from the first policy node includes: The first control node sends a charging policy request to the first policy node, where the charging policy request includes charging type information. The first control node receives a charging policy sent by the first policy node, where the charging policy is a charging policy corresponding to the charging type information.

In this implementation, the first control node may carry the charging type information in the charging policy request, so as to obtain a charging policy corresponding to a charging type.

In a possible implementation, the obtaining, by the first control node, the charging information from the first charging node includes:

The first control node sends a charging request to the first charging node, where the charging request includes one or more of the following charging configuration information: a charging type, charging manner information, and charging granularity information. The first control node receives charging information that corresponds to the charging configuration information and that is sent by the first charging node.

In this implementation, the first control node may carry the charging configuration information in the charging request, so as to obtain charging information corresponding to the charging configuration information.

In a possible implementation, the charging request further includes charging scenario information, where the charging scenario information includes at least one of the following: a scenario-based identifier for charging, a scenario-based parameter, a sub-scenario-based identifier for charging, and a sub-scenario-based parameter; and the charging information corresponds to the charging scenario information.

In this implementation, charging information corresponding to different scenarios is configured in a charging node. Therefore, the charging request may further include charging scenario information, to request to obtain charging information corresponding to a charging scenario, thereby meeting charging requirements in different scenarios and different sub-scenarios.

In a possible implementation, the first control node may send the charging rule to the at least one execution node in but not limited to the following two manners:
Manner 1: The first control node sends the charging rule to each of the at least one execution node.
Manner 2: The first control node sends the charging rule to a first execution node in the at least one execution node, to cause the first execution node to send the charging policy and the charging information to an execution node other than the first execution node in the at least one execution node.
In Manner 2, the first control node does not need to separately send the charging policy and the charging information to each execution node. The first control node may first send the charging policy and the charging information to an execution node, for example, an execution node that first performs a service task based on a service requirement, and then the execution node forwards the charging policy and the charging information, to simplify execution steps of the first control node, and reduce signaling overheads of the first control node.

In a possible implementation, the method further includes: The first control node receives resource utilization information that is of a requesting node and that is sent by the at least one execution node. The first control node sends the resource utilization information to the first charging node, where the first charging node is a charging node in a charging domain in which the first control node is located.

In a possible implementation, the method further includes: The first control node receives resource utilization information that is of a requesting node and that is sent by the at least one execution node. The first control node sends the resource utilization information to a second charging node or a settlement node in the second charging domain, where the first control node is a control node in the first charging domain.

In a scenario of convergent charging integrating a plurality of charging domains, resource utilization information of a user may be shared in the plurality of charging domains, and the first control node may send the resource utilization information to the second charging node or a second settlement node in the second charging domain, to cause a charging node or a settlement node in another charging domain to perform charging based on the resource utilization information.

In a possible implementation, the functional type includes one or more of the following types: traffic, duration, an event, a task, and the like; or the value type includes one or more of the following types: a rate, a latency, slice assurance, and content; or the resource type includes one or more of the following types: a computing resource, a storage resource, a network resource, a model resource, an algorithm resource, a data resource, an image resource, a software package resource, a code resource, and the like; or the scenario-based type includes one or more of the following types: a positioning scenario, a game acceleration scenario, a video decoding scenario, a video acceleration scenario, an in-band flow computing scenario, and the like.

According to a second aspect, an embodiment of this application provides a charging method, including: A first charging node sends charging information to a first control node, to cause the first control node to send the charging information to at least one first execution node, where the charging information includes charging information corresponding to at least one charging type, and the charging type includes one or more of the following types: a service type, a value type, a resource type, and a scenario-based type. The first charging node receives first resource utilization information that is reported based on the charging information.

In a possible implementation, the method further includes: The first charging node sends the first resource utilization information to a second charging node, where the first charging node is a charging node in a first charging domain, and the second charging node is a charging node in a second charging domain.

In a possible implementation, the method further includes: The first charging node receives third resource utilization information sent by a third control node or a third execution node, where the third control node is a control node in a third charging domain, and the third execution node is an execution node in the third charging domain.

In a possible implementation, the method further includes: The first charging node obtains a charging policy from a first policy node, where the charging policy includes a charging policy corresponding to the at least one charging type. The sending, by the first charging node, the charging information to the first control node includes: The first charging node sends the charging policy and the charging information to the first control node.

According to a third aspect, an embodiment of this application provides a charging method, including: A first execution node receives a charging rule sent by a first control node, where the charging rule includes a charging policy and charging information, or the charging rule is generated based on a charging policy and charging information, the charging policy includes a charging policy corresponding to at least one charging type, the charging information includes charging information corresponding to the at least one charging type, and the charging type includes one or more of the following types: a functional type, a value type, a resource type, and a scenario-based type. The first execution node reports resource utilization information according to the charging rule.

In a possible implementation, the method further includes: The first execution node sends the charging policy and the charging information to a second execution node, to cause the second execution node to report the resource utilization information based on the charging policy and the charging information, where the first execution node is an execution node in a first charging domain, and the second execution node is an execution node in the first charging domain or an execution node in a second charging domain.

According to a fourth aspect, an embodiment of this application provides a communication apparatus. The communication apparatus includes a module/unit that performs the method according to any one of the first aspect and the possible implementations of the first aspect, or includes a module/unit that performs the method according to any one of the second aspect and the possible implementations of the second aspect, or includes a module/unit that performs the method according to any one of the third aspect and the possible implementations of the third aspect. The apparatus may be a network device, or may be a component (for example, a processor, a chip, or a chip system) of the network device, or may be a logical node, a logical module, or software that can implement all or some functions of the network device. These modules/units may be implemented by hardware, or may be implemented by hardware executing corresponding software.

According to a fifth aspect, an embodiment of this application provides a communication device. The communication apparatus includes a processor, and a storage and a communication interface that are separately coupled to the processor. The communication interface is configured to communicate with another device. The processor is configured to: run instructions or a program in the storage, and perform, through the communication interface, the method according to any one of the first aspect and the possible implementations of the first aspect; or perform the method according to any one of the second aspect and the possible implementations of the second aspect; or perform the method according to any one of the third aspect and the possible implementations of the third aspect.

According to a sixth aspect, an embodiment of this application provides a computer-readable storage medium. The computer-readable storage medium stores instructions. When the instructions are run on a computer, the computer is caused to perform the method according to any one of the first aspect and the implementations of the first aspect, or perform the method according to any one of the second aspect and the implementations of the second aspect, or perform the method according to any one of the third aspect and the implementations of the third aspect.

According to a seventh aspect, an embodiment of this application provides a computer program product including instructions. When the instructions are run on a computer, the computer is caused to perform the method according to any one of the first aspect and the implementations of the first aspect, or perform the method according to any one of the second aspect and the implementations of the second aspect, or perform the method according to any one of the third aspect and the implementations of the third aspect.

According to an eighth aspect, an embodiment of this application provides a chip, including a processor, where the processor is coupled to a storage, and the storage is configured to store instructions. When the instructions are executed by the processor, the chip is caused to implement the method according to any one of the first aspect and the implementations of the first aspect, or implement the method according to any one of the second aspect and the implementations of the second aspect, or implement the method according to any one of the third aspect and the implementations of the third aspect.

For technical effects that can be achieved according to any one of the possible implementations in any one of the second aspect to the eighth aspect, refer to the descriptions of technical effects that can be achieved according to the corresponding implementation solution in the first aspect. Repeated parts are not described.

### BRIEF DESCRIPTION OF DRAWINGS

FIG. 1 is a diagram of a network architecture, in accordance with one or more embodiments;

FIG. 2 is a diagram of a charging granularity, in accordance with one or more embodiments;

FIG. 3 is a diagram of a charging procedure and message interaction, in accordance with one or more embodiments;

FIG. 4 is a schematic flowchart of a charging method, in accordance with one or more embodiments;

FIG. 5 is a schematic flowchart of a charging method, in accordance with one or more embodiments;

FIG. 6 is a schematic flowchart of a charging method, in accordance with one or more embodiments;

FIG. 7a and FIG. 7b are schematic flowcharts of a charging method, in accordance with one or more embodiments;

FIG. 8a and FIG. 8b are schematic flowcharts of a charging method, in accordance with one or more embodiments;

FIG. 9 is a diagram of a structure of a communication apparatus, in accordance with one or more embodiments; and

FIG. 10 is a diagram of a structure of a communication device, in accordance with one or more embodiments.

### DESCRIPTION OF EMBODIMENTS

As one of core basic functions of a mobile communication network, a charging function has existed from the dawn of the network. For a settlement system established by an operator according to a rule. Resource utilization of a user on the network is measured, and the user is charged.

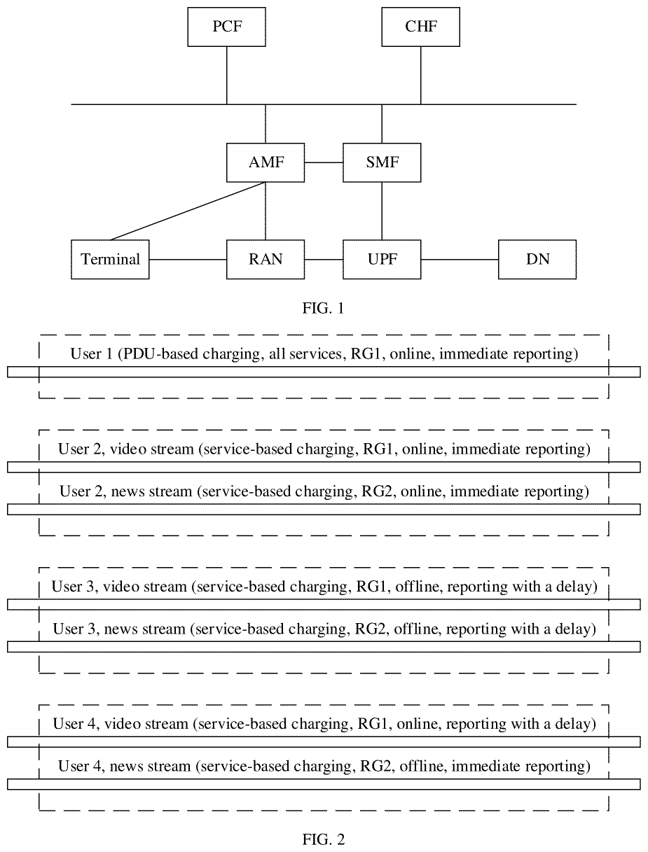

The following uses charging in a 5G mobile network as an example to describe a functional entity in the mobile communication network with reference to FIG. 1.

A terminal is a device that has a wireless transceiver function. The terminal is connected to a radio access network in a wireless manner, so as to access a communication system. The terminal may also be referred to as a terminal device, UE, a mobile station, a mobile termination, or the like. The terminal may be a mobile phone, a tablet computer, a computer with a wireless transceiver function, a virtual reality terminal device, an augmented reality terminal device, a wireless terminal in industrial control, a wireless terminal in self-driving, a wireless terminal in remote surgery, a wireless terminal in a smart grid, a wireless terminal in transportation safety, a wireless terminal in a smart city, a wireless terminal in a smart home, or the like. A specific technology and a specific device form that are used by the terminal are not limited in embodiments of this application. By way of example but not limitation, the terminal may alternatively be a wearable device, for example, glasses, gloves, a watch, clothing, and shoes. The wearable device is a portable device that can be directly worn on a body or integrated into clothes or accessories of the user. The wearable device is a hardware device, and also implements a powerful function through software support, data exchange, and cloud interaction. The terminal may alternatively be a vehicle-mounted module, a vehicle-mounted component, a vehicle-mounted chip, or a vehicle-mounted unit that is built in a vehicle as one or more components or units. The vehicle may implement the method in this application by using the built-in vehicle-mounted module, vehicle-mounted assembly, vehicle-mounted component, vehicle-mounted chip, or vehicle-mounted unit.

The radio access network (RAN) is configured to connect a terminal device to a wireless network. A network device located in the RAN may be referred to as an access network device or a base station. For example, the network device may be a base station, an evolved NodeB (eNodeB) in an LTE system or an evolved LTE system (LTE-A), a next generation NodeB (gNB) in a 5G communication system, a transmission reception point (TRP), a baseband unit (BBU), a Wi-Fi access point (AP), a base station in a future mobile communication system, an access node in a Wi-Fi system, or the like. The radio access network may alternatively be a module or a unit that completes some functions of the base station, for example, may be a central unit (CU) or a distributed unit (DU). A specific technology and a specific device form that are used by the radio access network are not limited in embodiments of this application. For example, in a network structure, the radio access network may be a CU node, a DU node, or a radio access network including a CU node and a DU node. The CU node is configured to support protocols such as a radio resource control (RRC) protocol, a packet data convergence protocol (PDCP), and a service data adaptation protocol (SDAP). The DU node is configured to support a radio link control (RLC) layer protocol, a medium access control (MAC) layer protocol, and a physical layer protocol.

An access and mobility management function (AMF) is mainly used for an attachment procedure, a mobility management procedure, a tracking area update procedure, and the like of a terminal device in a mobile network.

A session management function (SMF) is mainly used for session management in the mobile network, for example, session establishment, modification, and release. Example functions of the SMF are as follows: allocating an internet protocol (IP) address to a terminal, and selecting a user plane network element that provides a packet forwarding function. The SMF may also be configured to: process a charging parameter delivered by a CHF, collect, when a charging event occurs, information about resource utilization by a user and report the information to the CHF, perform quota monitoring on an online charging service, deliver a resource quota and a charging parameter to a UPF through an N4 interface, and process quota usage reporting by the UPF through the N4 interface.

The user plane function (UPF) is mainly used to handle a packet of the user, for example, perform forwarding and charging. For example, the UPF meters quota usage of the user based on the charging parameter and the quota delivered by the SMF, and reports the quota usage of the user to the SMF after a condition is met.

The charging function (CHF) is used to: perform rating, fee deduction, quota allocation, and charging parameter delivery for online charging, perform the following operations for offline charging: delivering a charging parameter, processing quota usage reported by the session management function (SMF), and generating a CHF call detail record (CDR), and so on.

The following describes technical concepts in this application.

A charging granularity may include cases of charging at a granularity of a PDU session, charging at a granularity of a service flow, charging at a granularity of a quality of service flow (QOS flow), and the like. One PDU session may include a plurality of service flows, or may include a plurality of QOS flows, but the service flows are not in one-to-one correspondence with the QoS flows. Charging at the granularity of the PDU session indicates that charging is performed on all traffic in the PDU session together, without distinguishing between the QoS flow and the service flow. Charging at the granularity of the service flow indicates that charging is performed based on a service, and different rates may be used for different service types. Charging at the granularity of the QoS flow indicates that charging is performed based on the QoS flow, and different rates may be used for different QoS flows.

A charging manner may include online charging and offline charging. The online charging refers to real-time online settlement. Quota utilization information is applied to balance calculation in real time. When a balance is insufficient, a service is terminated. The offline charging refers to quasi-real-time offline settlement, in other words, an event triggers quota usage settlement, and a real-time service is not affected. In a conventional charging mode, charging is mainly performed for traffic, call duration, and a quantity of short message services, and a corresponding charging quota may include a traffic quota, a quota on the call duration, and a quota on the quantity of short message services.

A charging event may include a charging event that is to be immediately reported and a charging event that is to be reported with a delay. When a charging event that needs to be immediately reported occurs, the SMF closes a current charging container and immediately reports the quota utilization information to the CHF. When the charging event that is to be reported with a delay occurs, the SMF may temporarily buffer information about the event, and report the buffered information to the CHF when a charging event that is to be immediately reported occurs next time.

In addition, the charging event may be used by distinguishing between a PDU granularity and a rating group (RG) granularity. A charging event at the PDU granularity takes effect for all RGs in a PDU session, and a charging event at the RG granularity only takes effect for a specified RG.

For example, PDU sessions for four users may be shown in FIG. 2. For a user 1, charging is performed at a granularity of the PDU session. In this case, charging is performed, at a same rate, on a service flow and a QoS flow (not shown in the figure) included in the PDU session, and a charging event of the user 1 is to be reported online immediately at an RG level. A PDU session of a user 2 includes a video service flow and a news service flow. Because the user 2 is charged at a granularity of a service flow, charging is performed separately on the video service flow and the news service flow based on respective rates. A charging event for a video service flow RG1 is to be reported online immediately, and a charging event for a news service flow RG2 is to be reported online immediately. A PDU session of a user 3 includes a video service flow and a news service flow. Because the user 3 is charged at a granularity of a service flow, charging is performed separately on the video service flow and the news service flow based on respective rates. A charging event for a video service flow RG1 is to be reported offline with a delay, and a charging event for a news service flow RG2 is to be reported offline with a delay. A PDU session of a user 4 includes a video service flow and a news service flow. Because the user 4 is charged at a granularity of a service flow, charging is performed separately on the video service flow and the news service flow based on respective rates. A charging event for a video service flow RG1 is to be reported online with a delay, and a charging event for a news service flow RG2 is to be reported online with a delay.

A requesting node is a node that initiates a service request. For example, a node that initiates a session establishment request and a task execution request is referred to as the requesting node. For example, the requesting node may be an AMF or an SMF. The requesting node may initiate a service request for a service requirement of the requesting node; or may initiate a service request for another node, for example, the AMF initiates a service request for UE; or may forward a service request of another node.

A control node is a node configured to control and schedule a task, a function, a resource, and the like together. For example, the control node may be an SMF or another entity.

A resource utilization node is a node that actually uses a resource. For example, when the AMF sends a service request to the SMF for the UE, the requesting node is the AMF, the control node is the SMF, and the resource utilization node is the UE. In other words, a resource allocated by the SMF is a resource used by the UE, an execution node allocated by the SMF is configured to provide a service for the UE, and the SMF obtains a charging policy, charging information, and the like of the UE. When the requesting node initiates a service request for the requesting node, the requesting node is also the resource utilization node.

The execution node is a node configured to perform a task or function and has a resource required for performing the task or function, for example, a node having a traffic forwarding function and video encoding and decoding functions. For example, the execution node may be a UPF or another entity.

A charging node is a node configured to perform charging based on usage information reported by the control node/the execution node. For example, the charging node may be a CHF or another entity.

A policy node is a node configured to store a charging manner and a charging method for a user service. For example, the policy node may be a PCF or another entity.

It should be understood that the foregoing nodes are functional nodes rather than physical nodes, and different functional nodes may be deployed in an integrated manner. A same physical node may also play different logical functional roles in different scenarios. For example, when establishing a session, the SMF may play a role of the control node. In a scenario in which a network provides a computing capability, as a computing capability provider, the SMF may alternatively play a role of the execution node.

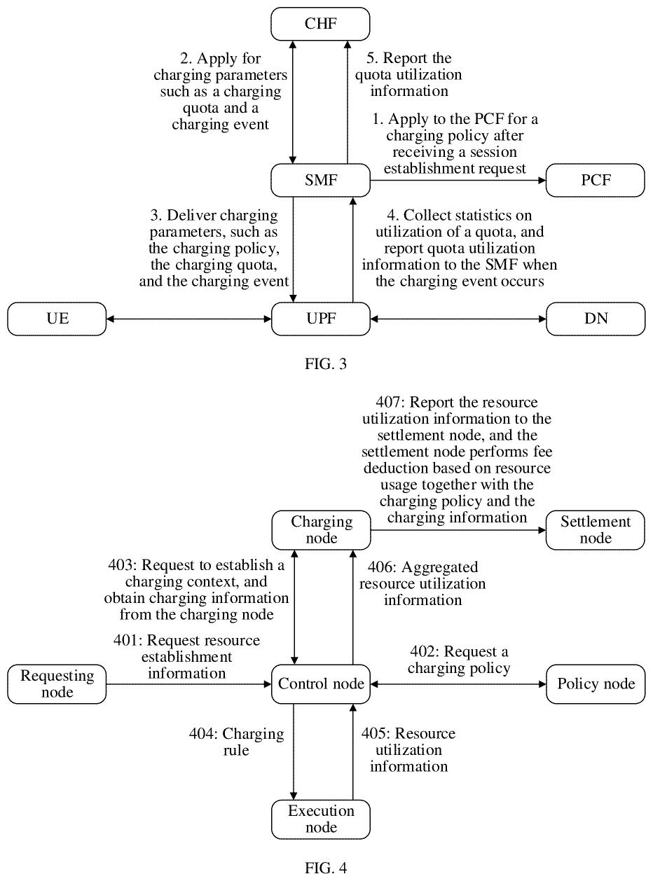

Based on a 5G network architecture shown in FIG. 1, a current conventional charging procedure and message interaction are shown in FIG. 3.

Step 1: After receiving a session establishment request, the SMF applies to the PCF for a charging policy. The charging policy may include a charging granularity and a charging manner.

Step 2: The SMF applies to the CHF for charging parameters such as a charging quota and a charging event.

Step 3: The SMF delivers charging parameters such as the charging policy, the charging quota, and the charging event to the UPF.

Step 4: The UPF collects statistics on utilization of a quota, and reports quota utilization information to the SMF when the charging event occurs.

Step 5: The SMF reports quota utilization information (and applies for a new quota if necessary) to the CHF.

A network data analytics function (NWDAF) is introduced into a latest mobile communication network. The NWDAF is configured to store data information collected in the network. However, for a current charging mode, there is no charging and settlement capability for collected data. A plurality of new capabilities of a plurality of service planes, such as a computing capability, an AI capability, and a sensing capability, may be further introduced into a future mobile communication network. Consequently, a current charging model based on traffic, duration, and an event cannot support charging and settlement for a new service.

In addition, a more integrated service in the future requires integration of multi-dimensional charging modes. For example, one-time AI computing may require resources from a plurality of perspectives such as a computing resource, traffic, and storage, and charging may need to be performed from the plurality of dimensions such as the computing resource, the traffic, and the storage. However, a single charging policy and single charging information cannot meet a charging requirement for the new service and a new capability.

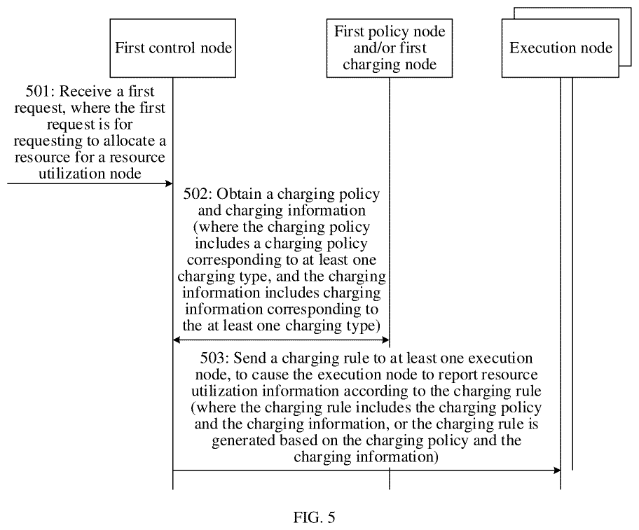

To resolve the foregoing problem, an embodiment of this application provides a charging method, to meet multi-dimensional charging requirements. FIG. 4 is an example of a schematic flowchart of a charging method. As shown in the figure, the method may include the following steps.

Step 401: A requesting node requests resource establishment information from a control node.

Optionally, the requesting node may send a resource establishment request to the control node, where the resource establishment request is for requesting the control node to establish a resource for the requesting node. The control node establishes a resource for a resource utilization node based on the resource establishment request, and sends the resource establishment information to the requesting node.

The requesting node may be one of a plurality of functional entities in a network, for example, UE/a RAN/an NF. Correspondingly, the control node may also be one of the plurality of functional entities. A 5G scenario is used as an example. When an AMF requests an SMF to establish a session, the requesting node is the AMF, and the control node is the SMF. When an NEF requests the SMF to obtain a UE location event, the requesting node is the NEF, and the control node is the SMF. In a possible future-oriented scenario, if the UE requests network-assisted computing based on a NAS message, the requesting node is the UE, and the control node is a node with assisted computing, for example, an SMF. Alternatively, if the UE forwards a data packet via a UPF, to trigger a network to encode and decode the packet, the requesting node is the UE, and the control node is the UPF. The requesting node may request to establish a resource for the requesting node; or may request to establish a resource for another node (namely, the resource utilization node), for example, the AMF requests to establish a resource for the UE. Alternatively, the requesting node may forward a resource establishment request of the resource utilization node to the control node.

Step 402: The control node requests a charging policy from a policy node.

In an implementation, the control node may send a charging request to the policy node, to request to obtain the charging policy of the resource utilization node. After receiving the charging request, the policy node returns the required charging policy to the control node based on the charging request. Optionally, the charging policy may include a charging granularity, a charging manner, and the like.

The charging granularity may include a PDU session granularity, a service flow granularity, and a QoS flow granularity. It should be understood that, in a future-oriented communication scenario, the charging granularity may further include a granularity other than the foregoing granularities.

The charging manner may include an online charging manner or an offline charging manner, or another charging manner integrating both online charging and offline charging.

Step 403: The control node requests a charging node to establish a charging context, and obtains charging information from the charging node.

Optionally, the control node may send a charging context establishment request to the charging node. The charging node establishes a charging context for the resource utilization node based on the request, and sends the charging information of the resource utilization node to the control node. The charging information may include a resource quota, a charging event, and the like.

In a possible implementation, if the control node does not perform step 402, when the control node requests the charging node to establish the charging context, the charging node may further obtain the charging policy from the policy node, and then send the charging policy and the charging information to the control node.

Step 404: The control node sends a charging rule to an execution node. The charging rule includes the charging policy and the charging information, or the charging rule is generated based on the charging policy and the charging information.

When establishing the resource for the resource utilization node, the control node may determine an execution node that provides a resource for the resource utilization node. After obtaining the charging rule, the control node sends the charging rule to the determined execution node, to cause the execution node to report resource utilization information of the resource utilization node according to the charging rule. After obtaining the charging policy and the charging information, the execution node may generate the charging rule based on the charging policy and the charging information, and then report the resource utilization information of the resource utilization node according to the charging rule. If the charging rule sent by the control node includes the charging policy and the charging information, the execution node may generate a corresponding rule based on the charging policy and the charging information, and then report the resource utilization information according to the corresponding rule.

Step 405: The execution node reports the resource utilization information to the control node.

If an allocated resource quota has been used up or is to be used up, the execution node may further apply for allocation of a new resource quota when reporting the resource utilization information.

Step 406: The control node reports aggregated resource utilization information to the charging node.

If the execution node requests to allocate the new resource quota when reporting the resource utilization information, the control node may request, when the control node reports the aggregated resource utilization information to the charging node, the charging node to allocate the new resource quota.

Step 407: The charging node reports the resource utilization information to a settlement node, and the settlement node performs fee deduction based on resource usage together with the charging policy and the charging information.

To implement charging integrating a plurality of charging types, an embodiment of this application further provides a charging method shown in FIG. 5. As shown in the figure, the method may include the following steps.

Step 501: A first control node receives a first request, where the first request is for requesting to allocate a resource for a resource utilization node.

The first control node is a control node in a first charging domain, and the first control node receives the first request sent by a requesting node. The requesting node may be a requesting node in the first charging domain, or may be a requesting node in another charging domain, for example, a requesting node in a second charging domain. The requesting node may request to allocate a resource for the requesting node, that is, the requesting node is the resource utilization node, or the requesting node may alternatively request to allocate a resource for another node (namely, the resource utilization node).

In embodiments of this application, a charging domain represents a system having an independent charging capability. Different charging domains may be different communication networks, different geographical areas, different service platforms, or the like. For example, a communication network provided by a communication operator 1 may be referred to as a charging domain 1, and a network provided by a communication operator 2 may be referred to as a charging domain 2. For another example, a communication network provided by a communication operator 1 may be referred to as a charging domain 1, and a communication network in an industrial park 1 may be referred to as a charging domain 2. For still another example, a communication network provided by a communication operator may be referred to as a charging domain 1, and a service system that has a charging capability and that is provided by a third-party service platform may be referred to as a charging domain 2.

Optionally, the first request received by the first control node may be a resource establishment request sent by the requesting node, and the resource establishment request is for requesting the first control node to establish a resource for the resource utilization node. After receiving the resource establishment request, the first control node establishes a resource for the resource utilization node, and performs the charging method provided in embodiments of this application, to charge the resource utilization node.

Step 502: The first control node obtains a charging policy and charging information, where the charging policy includes a charging policy corresponding to at least one charging type, and the charging information includes charging information corresponding to the at least one charging type.

Optionally, the charging policy may include a charging granularity, a charging manner, and the like. As described above, the charging granularity may include a PDU session granularity, a service flow granularity, and a QoS flow granularity. It should be understood that, in a future-oriented communication scenario, the charging granularity may further include a granularity other than the foregoing granularities. The charging manner may include an online charging manner or an offline charging manner, or another charging manner integrating both online charging and offline charging.

The charging information may include a charging event, a resource quota, and the like. The charging event may include a charging event that is to be immediately reported and a charging event that is to be reported with a delay, and may further include charging events at different granularities, for example, a charging event at a PDU granularity and a charging event at an RG granularity. Alternatively, the charging event may further include a charging event of another type. The resource quota represents a resource quota allocated to a user (namely, a user served by the first request). For example, traffic with a quota of 10G is allocated to a user A. When traffic of the user A reaches 10G, a traffic service of the user A is suspended or a traffic quota is re-allocated to the user A.

The charging policy/the charging information obtained by the first control node includes the charging policy/charging information corresponding to the at least one charging type. Optionally, the charging type may include the following:
a functional type, for example, traffic, duration, an event, and a task;
a value type, for example, a rate, a latency, slice assurance, and high-value content;
a resource type, for example, a computing resource, a storage resource, a network resource, an AI model resource, an algorithm resource, a data resource, an image resource, a software package resource, and a code resource; and
a scenario-based type, for example, high-precision positioning, game acceleration, video decoding, video acceleration, and in-band flow computing.

For example, the charging policy/the charging information obtained by the first control node may include a charging policy/charging information corresponding to the traffic, a charging policy/charging information used for slice assurance, a charging policy/charging information for using the computing resource, a charging policy/charging information used for video decoding, and the like.

It should be understood that each charging type may include but is not limited to the foregoing examples, and the foregoing types are not classified in a completely orthogonal manner. For a same resource/function, there may be other different types in different scenarios.

In a possible implementation, the first control node may obtain the charging policy from a first policy node in the first charging domain, and obtain the charging information from a first charging node in the first charging domain. For example, the first control node may send a charging policy request to the first policy node, to request to obtain the charging policy of the resource utilization node. After receiving the charging policy request, the first policy node returns the required charging policy to the control node based on the charging policy request. For another example, when obtaining the charging information from the first charging node, the first control node may send a charging request to the first charging node, to request to obtain the charging information. The charging request may be the charging context establishment request in the foregoing embodiment, or may be another request for obtaining the charging information.

Optionally, the charging policy request sent by the first control node to the first policy node may include a charging type. Correspondingly, after receiving the charging policy request, the first policy node may send, based on the charging type included in the charging policy request, a charging policy corresponding to the charging type to the first control node. For example, if the charging policy request sent by the first control node includes information about a charging type indicating traffic, after receiving the request, the first policy node sends a charging policy for traffic of the user to the first control node. For another example, if the charging policy request sent by the first control node does not include information about a charging type, the first policy node may send all types of charging policies to the first control node.

In addition, the charging policy request may further include a resource specification, where the resource specification may include QoS, a latency, a computing capability, a data type, and the like.

Optionally, the charging context establishment request sent by the first control node to the first charging node may include a charging type. Correspondingly, the first charging node sends charging information corresponding to the charging type to the first control node.

Further, the charging request may further include one or more of the following charging scenario information: a scenario-based identifier for charging, a scenario-based parameter, a sub-scenario-based identifier for charging, a sub-scenario-based parameter, a resource type, resource usage, and the like. For example, the charging request includes the scenario-based identifier for charging: indicating video decoding (or indicating a video decoding service ID); the sub-scenario-based identifier: live video decoding; and the scenario-based parameter: a live video decoding algorithm, whether hardware acceleration is performed, and the like. When the charging request includes the foregoing information, the resource type in the charging request may further indicate a resource quality limitation required to meet a quality requirement for a scenario-based task. For example, a video decoding service requires a decoding rate of X Mbps/s, and resource usage may be Y Mbps/s. If a resource type and resource usage are not additionally specified, execution quality of a scenario-based service may not be ensured.

Correspondingly, after receiving the charging request that includes the charging scenario information, the first charging node determines charging information corresponding to the charging scenario information, and sends the charging information to the first control node. For example, when the charging request includes information such as the live video decoding, the decoding rate of X Mbps/s, and the resource usage that may be Y Mbps/s, the first charging node determines charging information in a live video decoding scenario, and determines, based on the decoding rate and the resource usage, the resource quota allocated to the user, and the like.

In another possible implementation, the first control node may alternatively obtain the charging policy and the charging information from the first charging node. For example, when the first control node sends a charging request to the first charging node, the first charging node may further obtain the charging policy from the policy node, and then send the charging policy and the charging information to the control node. The charging request sent by the first control node may carry a charging type, and the first charging node sends a charging policy and charging information corresponding to the charging type to the first control node.

Step 503: The first control node sends a charging rule to at least one execution node, to cause the at least one execution node to report resource utilization information based on the charging policy and the charging information.

The charging rule includes the charging policy and the charging information, or the charging rule is generated based on the charging policy and the charging information.

After receiving the first request, the first control node may determine the at least one execution node that provides a service for the resource utilization node, and after obtaining the charging rule, send the charging rule to the at least one execution node that provides the service for the resource utilization node.

The at least one execution node determined by the first control node may include at least one first execution node, namely, an execution node in the first charging domain, and may further include at least one second execution node, where the second execution node is an execution node in the second charging domain. Alternatively, the at least one execution node may include both the first execution node and the second execution node.

When there are a plurality of execution nodes that provide services for the resource utilization node, in a possible implementation, the first control node may separately send the charging rule to each execution node that provides a service for the resource utilization node, to cause each execution node to report the resource utilization information according to the charging rule.

In another possible implementation, the first control node may send the charging rule to a target execution node (which is one of the plurality of execution nodes that provide the services for the resource utilization node), and then the target execution node sends the charging rule to another execution node (namely, an execution node other than the target execution node in the plurality of execution nodes that provide the services for the resource utilization node). For example, there are three execution nodes that provide services for the resource utilization node, and the three execution nodes are an execution node A, an execution node B, and an execution node C in a service execution sequence. The execution node A receives the charging rule sent by the first control node, and the execution node A may separately send the rule to the execution node B and the execution node C. Alternatively, the execution node A may send the charging rule to the execution node B, and then the execution node B sends the charging rule to the execution node C, to cause all of the execution node A, the execution node B, and the execution node C to report the resource utilization information of the resource utilization node according to the charging rule. For another example, the first control node sends the charging rule including the charging policy and the charging information to the execution node A. The execution node A generates a corresponding rule based on the charging policy and the charging information, and then sends the corresponding rule that is generated to the execution node B. The execution node B sends the corresponding rule to the execution node C. The execution node A and the first control node may both be nodes in the first charging domain. The execution node B may be an execution node in the first charging domain, or may be an execution node in the second charging domain. The execution node C may be an execution node in the first charging domain, or may be an execution node in the second charging domain.

Further, each execution node may report, to the first control node, information about resource utilization that is performed by the resource utilization node via the execution node, and the first control node aggregates resource utilization information reported by execution nodes. The first control node may report the aggregated resource utilization information to the first charging node in the first charging domain. If the first control node determines, based on the aggregated information, that for the resource utilization node, a new resource quota needs to be applied for, the first control node may further apply to the first charging node in the first charging domain for the new resource quota.

Optionally, each execution node may alternatively directly report, to the first charging node, information about resource utilization that is performed by the resource utilization node via the execution node, and the first charging node aggregates resource utilization information.

Considering that the resource utilization information needs to be aggregated and temporarily stored, the execution node may alternatively report the resource utilization information to the first charging node via a resource reporting center. For example, the execution node sends the resource utilization information to the resource reporting center, and the resource reporting center aggregates and processes resource utilization information sent by each execution node, and then sends aggregated resource utilization information to a computing node. In this implementation, the resource reporting center may aggregate and buffer resource utilization information that is of the user and that is at different slices and in different network spaces. The resource reporting center may be used as a storage unit, so that the resource reporting center is decoupled from a main service procedure, and the resource utilization information is not lost due to a fault in a service NF or a storage center NF.

After receiving the aggregated resource utilization information that is sent by the first control node or the aggregated resource utilization information that is sent by the resource reporting center, the first charging node may send the received resource utilization information to a first settlement node in the first charging domain. The first settlement node may perform fee deduction based on resource utilization information of the user and according to a charging rule of the user. If the first charging node directly receives the resource utilization information reported by each execution node, the first charging node may aggregate and process the resource utilization information reported by each execution node, and then perform fee deduction based on aggregated and processed resource utilization information and according to the charging rule.

When an execution node that provides a service for the resource utilization node includes both a first execution node in the first charging domain and a second execution node in the second charging domain, the first execution node may report the resource utilization information to the first control node or another node in the first charging domain, and the second execution node may report the resource utilization information to a second control node in the second charging domain or another node in the second charging domain.

In an emerging or future service scenario, multi-domain convergent charging may be required. For example, when the user served by the first request is a subscriber of the second charging domain, or when the user served by the first request needs to utilize both a resource provided by the first charging domain and a resource provided by the second charging domain, joint charging needs to be performed in both the first charging domain and the second charging domain. Although independent charging can be performed in different charging domains, in a current charging method, joint charging cannot be performed in a plurality of charging domains. To resolve the foregoing problem, the charging policy and the charging information may be shared among the plurality of charging domains, so as to implement multi-domain convergent charging.

In a possible implementation, the first control node in the first charging domain sends the charging policy and the charging information to the second control node in the second charging domain, so that the second control node in the second charging domain can also obtain the corresponding charging policy and corresponding charging information, to cause the second charging domain to perform charging and settlement on the resource utilization node based on the charging policy and the charging information.

In another possible implementation, if the second charging domain also provides a resource for the resource utilization node, the execution node in the first charging domain may alternatively send the charging policy and the charging information to the execution node in the second charging domain. After receiving the charging policy and the charging information, the execution node in the second charging domain collects statistics on resource utilization information of the user based on the charging policy and the charging information, and reports the statistics to the second control node, the resource reporting center, or a second charging node.

Optionally, in the foregoing implementation, the first control node may send indication information to the first execution node, where the indication information indicates the first execution node to send the charging policy and the charging information to the second execution node in the second charging domain. The first execution node may send the obtained charging policy and charging information to the second execution node. Alternatively, the first execution node may generate the charging rule based on the obtained charging policy and charging information, and then send the charging rule to the second execution node.

It should be understood that, in the foregoing embodiments, an example in which the first control node obtains the charging policy and the charging information respectively from the first policy node and the first charging node is used for description. In a multi-domain convergent charging scenario, the first control node may further obtain a charging policy and charging information of another charging domain from a policy node, a charging node, or a control node of the another charging domain. Alternatively, when the first control node obtains the charging policy and the charging information respectively from the first policy node and the first charging node, the first policy node and/or the first charging node may further obtain a charging policy and charging information of another charging domain from a policy node and/or a charging node of the another charging domain, and then send the charging policy and the charging information to the first control node.

Further, the first charging domain may further send the resource utilization information of the resource utilization node to the second charging domain, so that the second charging domain performs charging and fee deduction based on the resource utilization information. A manner in which the first charging domain sends the resource utilization information of the resource utilization node to the second charging domain may include but is not limited to the following manners.
Manner 1: After receiving resource utilization information reported by each execution node, the first control node may send aggregated and processed resource utilization information to the second charging node in the second charging domain. After receiving the resource utilization information that is of the user and that is sent by the first control node, the second charging node may send the resource utilization information of the user to a second settlement node in the second charging domain, so that the second settlement node performs fee deduction on the user. For example, the user is a subscriber in the second charging domain. When the user roams to the first charging domain, the first execution node in the first charging domain provides a service and a resource for the user, the first execution node reports resource utilization information of the user to the first control node, and then the first control node sends the resource utilization information to the second control node in the second charging domain, so that the second control node reports, to the second charging node, the resource utilization information that is of the user and that is in the first charging domain, to cause the second charging node to report the resource utilization information of the user to the second settlement node in the second charging domain, so that the second settlement node performs fee deduction on the user.
Manner 2: When the first execution node in the first charging domain reports resource utilization information to the resource reporting center, the resource reporting center may alternatively send aggregated resource utilization information to the second charging node in the second charging domain, and then the second charging node sends the resource utilization information to the second settlement node in the second charging domain. Alternatively, the resource reporting center may send the resource utilization information to the second settlement node, so that the second settlement node performs fee deduction on the user.
Manner 3: After receiving resource utilization information reported by each first execution node, the first control node sends aggregated resource utilization information to the first charging node, and then the first charging node sends the resource utilization information to the second charging node or the second settlement node in the second charging domain, so that the second charging node/the second settlement node performs fee deduction.

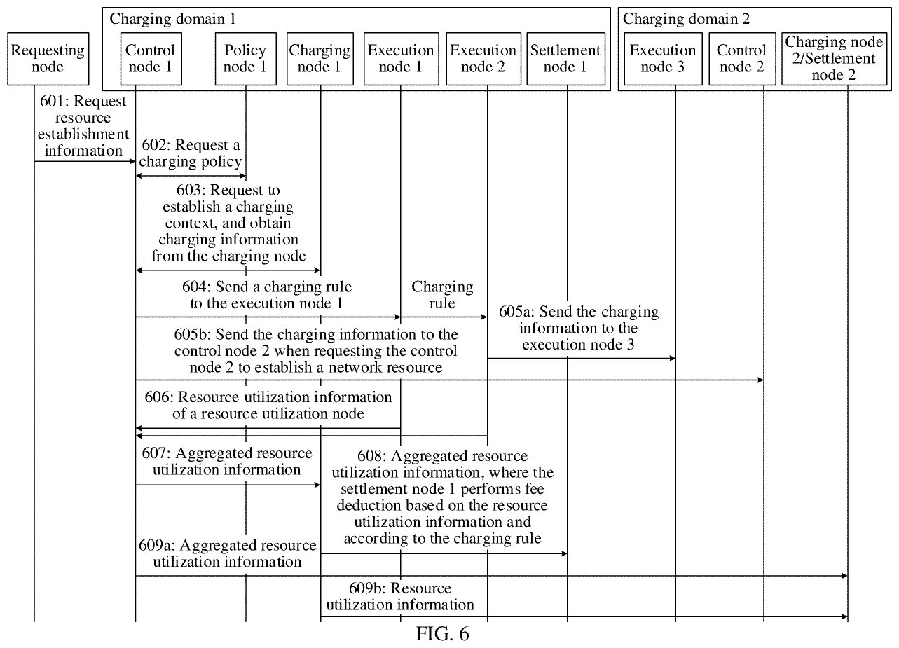

For clearer understanding of the foregoing embodiments of this application, examples are provided below for description with reference to FIG. 6 to FIG. 8b.

In an embodiment shown in FIG. 6, a service related to a user requires multi-domain charging, for example, in a roaming scenario or a scenario for co-construction and sharing, or the user may belong to an organization, for example, a vertical industry, a campus, or an integrator. Different types of organizations may have different assets. For example, an operator A may have complete network resources (including an independent charging node, policy node, control node, execution node, and the like). An integrator may have no network asset. For example, an OTT vendor does not have a network asset, but has a requirement for independent charging on a service for which the OTT vendor cooperates with the operator A. As shown in the figure, the embodiment may include the following steps.

Step 601: A requesting node requests resource establishment information from a control node 1.

A resource utilization node needs to utilize a resource in a charging domain 1. Therefore, the requesting node requests the resource establishment information from the control node 1 in the charging domain 1, and allocate a resource to the resource utilization node.

The requesting node and the resource utilization node may be a same node or different nodes.

Step 602: The control node 1 requests a charging policy from a policy node 1. This step is an optional step.

After receiving the request on the resource establishment information, the control node 1 establishes a resource for the requesting node, and may further send a charging request to the policy node 1 in the charging domain 1, to request to obtain the charging policy. After receiving the charging request, the policy node 1 returns the required charging policy to the control node 1 based on the charging request. The charging policy may include a charging granularity, a charging manner, and the like.

Step 603: The control node 1 requests a charging node 1 to establish a charging context, and obtains charging information from the charging node.

The control node 1 may send a charging context establishment request to the charging node 1 in the charging domain 1. The charging node 1 establishes a charging context for the requesting node 1 based on the request, and sends the charging information to the control node 1. The charging information may include a resource quota, a charging event, and the like.

In a possible implementation, if the control node 1 does not perform step 602, when the control node 1 requests the charging node 1 to establish the charging context, the charging node 1 may further obtain the charging policy from the policy node 1, and then send the charging policy and the charging information to the control node 1.

Step 604: The control node 1 sends a charging rule to an execution node 1, and the execution node 1 sends the charging rule to an execution node 2.

The charging rule includes the charging policy and the charging information, or the charging rule is generated based on the charging policy and the charging information.

When establishing a resource for the resource utilization node, the control node 1 may determine that execution nodes of the resource utilization node include the execution node 1 and the execution node 2 in the charging domain 1. After obtaining the charging rule, the control node 1 sends the charging rule to the execution node 1, so that the execution node 1 sends the charging policy and the charging information to the execution node 2. Alternatively, the control node 1 may respectively send the obtained charging policy and charging information to the execution node 1 and the execution node 2.

Step 605a: The execution node 2 sends the charging policy and the charging information to an execution node 3.

The execution node 3 is an execution node in a charging domain 2.

The sending performed by the execution node 2 is merely an example, and the execution node 1 may alternatively send the charging policy and the charging information to the execution node 3.

Step 605b: When requesting the control node 2 to establish a network resource, the control node 1 sends the charging information to the control node 2.

The control node 2 is a control node in the charging domain 2.

Either step 605a or step 605b may be performed. An execution sequence for step 605b is not limited in embodiments of this application, and step 605b may be performed before step 604, or may be performed after step 604.

Step 606: The execution node 1 and/or the execution node 2 report resource utilization information of the resource utilization node to the control node 1.

The execution node 1 and/or the execution node 2 may further apply for a new resource quota when reporting the resource utilization information. For example, when a resource quota allocated by the charging node 1 is fully utilized, the execution node 1 and/or the execution node 2 may apply for a new resource quota.

Step 607: The control node 1 reports aggregated resource utilization information to the charging node 1.

If the execution node 1 and/or the execution node 2 apply to the control node 1 for the new resource quota in step 606, the control node 1 may apply to the charging node 1 for the new resource quota.

Step 608: The charging node 1 reports the aggregated resource utilization information to a settlement node 1, and the settlement node 1 performs fee deduction based on the resource utilization information and according to the charging rule.

Step 609a: The control node 1 sends the aggregated resource utilization information to a charging node 2 or a settlement node 2.

The charging node 2 and the settlement node 2 are charging nodes and settlement nodes in the charging domain 2.

Step 609b: The charging node 1 sends the resource utilization information to the charging node 2 or the settlement node 2.

Either step 609a or step 609b may be performed. Alternatively, the execution node 1 and the execution node 2 send the resource utilization information to a resource reporting center (not shown in the figure), and the resource reporting center sends the aggregated resource utilization information to the charging node 2 or the settlement node 2.

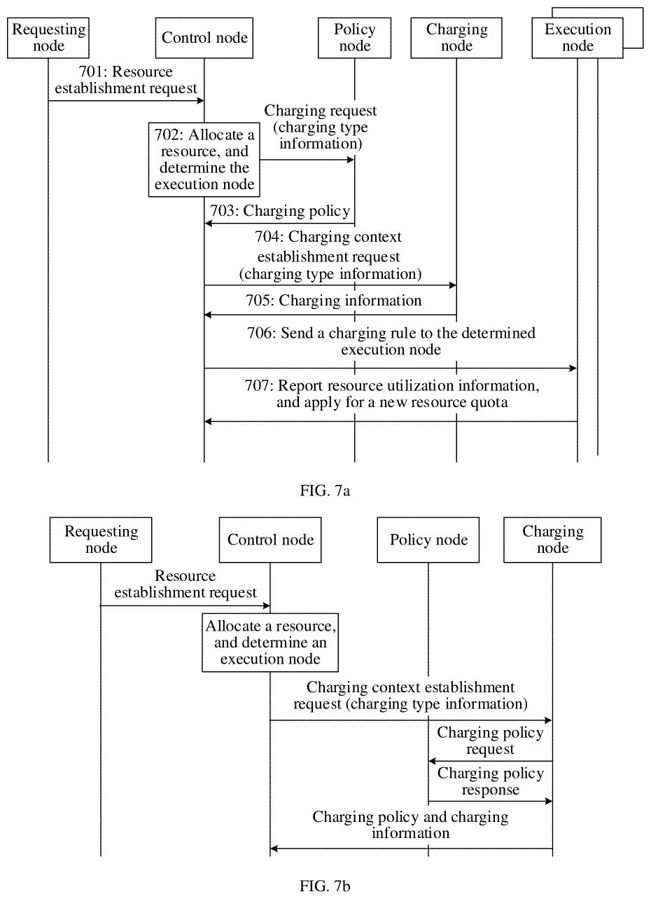

In an embodiment shown in FIG. 7a, a charging domain is used as an example to describe a charging policy and charging information in detail. It should be understood that the embodiment shown in FIG. 7a may be combined with any one of embodiments in FIG. 4 to FIG. 6. As shown in FIG. 7a, the embodiment may include the following steps.

Step 701: A requesting node sends a resource establishment request to a control node.

The resource establishment request is for requesting the control node to find a proper execution node and allocate a resource required for service execution.

Step 702: The control node allocates a resource, determines an execution node, and sends a charging request to a policy node.

The charging request is for obtaining a charging policy of a user in the service state, and the charging request may include information about a charging type, so that the policy node returns a charging policy corresponding to a charging type.

Step 703: The policy node sends the charging policy to the control node.

The charging policy may include a charging manner, a charging granularity, and the like.

For example, if the charging request may include a traffic identifier and a call duration identifier, the policy node returns, to the control node, a charging policy of traffic and a charging policy of call duration. Certainly, the charging request may alternatively not include a charging type, and the policy node may send, to the control node, all charging policies of charging types that may be related to the user.

Step 704: The control node sends a charging context establishment request to a charging node.

The charging context establishment request is for obtaining charging information of a service when the user executes the service. The charging context establishment request may include information such as a charging type and a resource specification (for example, QoS, a latency, a computing capability, and a data type), so that the charging node returns charging information of a corresponding type.

Step 705: The charging node sends charging information to the control node.

For example, if the charging context establishment request includes information such as a traffic identifier and a QoS requirement, the charging node sends traffic-related charging information that meets the QOS requirement to the control node.

It should be understood that the policy node and the charging node may be deployed separately, or may be deployed together. In a multi-domain charging scenario, the control node may request a charging domain in which a service is located to obtain a charging policy and charging information, and the charging domain in which the service is located obtains a charging policy and charging information of another charging domain; or may separately obtain a charging policy and charging information from a plurality of charging domains.

In another possible implementation, a procedure in which the control node obtains a charging policy and charging information may alternatively be shown in FIG. 7b. The requesting node sends a resource establishment request to the control node. The control node allocates a resource and determines an execution node. The control node sends a charging context establishment request to the charging node. The charging node obtains a charging policy from the policy node based on the charging context establishment request. The charging node sends the charging policy and the charging information to the control node.

Step 706: The control node sends a charging rule to the determined execution node.

The charging rule may include the charging policy and the charging information, or the charging rule is generated based on the charging policy and the charging information.

In a case in which there are a plurality of execution nodes, the control node may respectively send a charging rule to the plurality of execution nodes. For example, the control node may send a corresponding charging policy and charging information based on a type of a service that each execution node is responsible for performing. Alternatively, the control node may send a charging rule to one of the execution nodes, and then the execution node sends the charging rule to another execution node.

Step 707: The execution node reports resource utilization information and applies for a new resource quota.

When a triggering condition is met, the execution node may report the resource utilization information to the control node, a resource reporting center, or the charging node. When there is a need to apply for a new resource quota needs, the execution node may report to the control node to apply for the new resource quota, so that the control node applies to the charging node for the new resource quota. Alternatively, the execution node may directly apply to the charging node for the new resource quota.

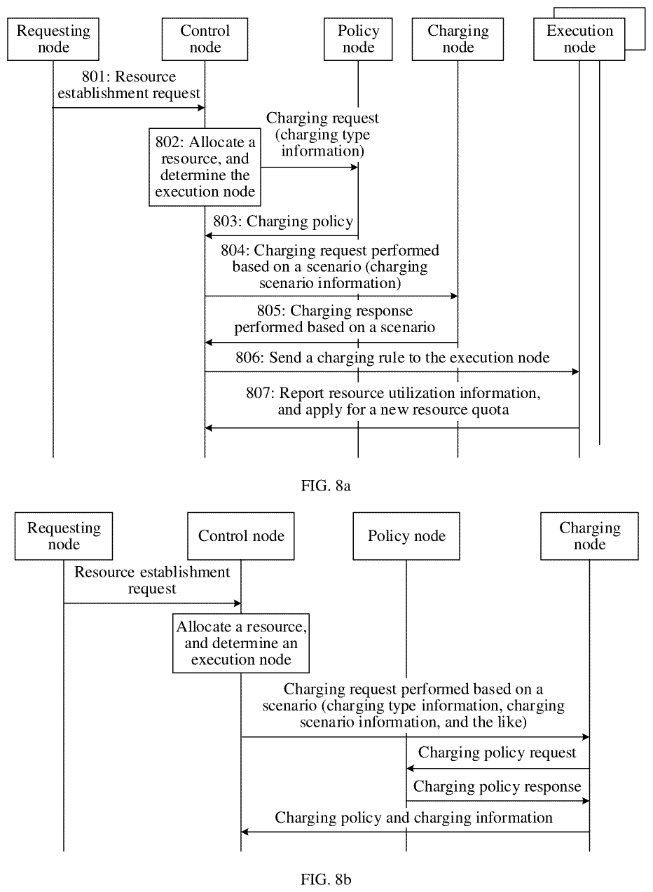

In an embodiment shown in FIG. 8a, charging is performed based on a scenario-based user service, without paying attention to a combination of resources used by the user when performing the scenario-based service (for example, when charging is performed for one-time video encoding and decoding of the user, attention only needs to be paid to a size of encoded and decoded video streams, without paying attention to a CPU, a memory, and a network resource that are used for decoding a video stream). As shown in FIG. 8a, the embodiment may include the following steps.

Step 801 to step 803 are similar to step 701 to step 703. Details are not described herein again.

Step 804: A control node sends, to a charging node, a charging request that is performed based on a scenario, where the request may include one or more of the following charging scenario information: a scenario-based identifier, a sub-scenario-based identifier, a scenario-based parameter, a charging type, resource usage, and the like.

Step 805: The charging node sends, to the control node, a charging response that is performed based on a scenario, where the response includes charging information that corresponds to the scenario-based identifier, the sub-scenario identifier, the scenario-based parameter, the charging type, and the resource usage in the request.

In another possible implementation, a procedure in which the control node obtains a charging policy and charging information may alternatively be shown in FIG. 8b. A requesting node sends a resource establishment request to the control node. The control node allocates a resource and determines an execution node. The control node sends, to the charging node, a charging request that is performed based on a scenario, where the request may include charging type information, charging scenario information, and the like. The charging node obtains a charging policy from a policy node based on the charging request that is performed based on a scenario, that is, obtains a charging policy corresponding to the charging type information and the charging scenario information. The charging node sends the charging policy and the charging information to the control node.

Step 806: The control node sends a charging rule to the execution node.

The charging rule may include the charging policy and the charging information, or the charging rule is generated based on the charging policy and the charging information.

In scenario-based service-based charging, the control node may sequentially deliver, based on an execution sequence of execution nodes, a charging policy and charging information related to each execution node, or may send a charging policy and charging information to an execution node that first performs a task. When completing the task, the execution node sends the charging policy and the charging information to a next execution node that performs a task, and so on.

For step 807, refer to step 707. Details are not described herein again.

In the charging method provided in embodiments of this application, a single charging policy and single charging information are not used, and different charging policies and charging information may be used for different charging types. For example, charging policies and charging information may be respectively configured for traffic, duration, and an event based on a functional type, or charging policies and charging information may be respectively configured for a computing resource, a storage resource, and an AI model resource based on a resource type, or charging policies and charging information may be respectively configured for high-precision positioning, a game, and video decoding based on a scenario, to meet diversified charging requirements for different services. In addition, in embodiments of this application, convergent charging integrating a plurality of charging domains can be further implemented, and a requirement for convergent charging in an emerging and future multi-domain communication scenario can be met.

Based on a same technical concept, an embodiment of this application further provides a communication apparatus, including modules/units that perform the network device in the foregoing method embodiments. The apparatus may be a network device, or may be a component (for example, a processor, a chip, or a chip system) of the network device, or may be a logical node, a logical module, or software that can implement all or some functions of the network device. These modules/units may be implemented by hardware, or may be implemented by hardware executing corresponding software.

For example, the communication apparatus may be shown in FIG. 9, and includes a communication module 901 and a processing module 902. The communication module 901 is configured to receive and send a message, and the processing module 902 is configured to implement message processing by the communication apparatus. It should be understood that, in embodiments of this application, the processing module 902 may be implemented by a processor or a processor-related circuit component (or referred to as a processing circuit). The communication module 901 may be implemented by a transceiver or a transceiver-related circuit component.

When the communication apparatus is a first control node, the processing module 902 may be configured to: receive a first request via the communication module 901, where the first request is for requesting to allocate a resource; obtain a charging policy and charging information, where the charging policy includes a charging policy corresponding to at least one charging type, the charging information includes charging information corresponding to the at least one charging type, and the charging type includes one or more of the following types: a functional type, a value type, a resource type, and a scenario-based type; and send a charging rule to at least one execution node, where the charging rule includes the charging policy and the charging information, or the charging rule is generated based on the charging policy and the charging information, to cause the at least one execution node to report resource utilization information according to the charging rule, and the at least one execution node is an execution node that is configured to provide a resource and that is allocated by the first control node.

In addition, the foregoing modules may be further configured to support another process performed by the first control node in the embodiments shown in FIG. 4 to FIG. 8b. For beneficial effects, refer to the foregoing descriptions. Details are not described herein again.

When the communication apparatus is a first charging node, the processing module 902 may be configured to: send charging information to a first control node via the communication module 901, to cause the first control node to send the charging information to at least one first execution node, where the charging information includes charging information corresponding to at least one charging type, and the charging type includes one or more of the following types: a service type, a value type, a resource type, and a scenario-based type; and receive first resource utilization information that is reported based on the charging information.

In addition, the foregoing modules may be further configured to support another process performed by the first charging node in the embodiments shown in FIG. 4 to FIG. 8b. For beneficial effects, refer to the foregoing descriptions. Details are not described herein again.

When the communication apparatus is a first execution node, the processing module 902 may be configured to receive, via the communication module 901, a charging rule sent by a first control node, where the charging rule includes a charging policy and charging information, or the charging rule is generated based on a charging policy and charging information, the charging policy includes a charging policy corresponding to at least one charging type, the charging information includes charging information corresponding to the at least one charging type, and the charging type includes one or more of the following types: a functional type, a value type, a resource type, and a scenario type; and report resource utilization information according to the charging rule.

In addition, the foregoing modules may be further configured to support another process performed by the first execution node in the embodiments shown in FIG. 4 to FIG. 8b. For beneficial effects, refer to the foregoing descriptions. Details are not described herein again.

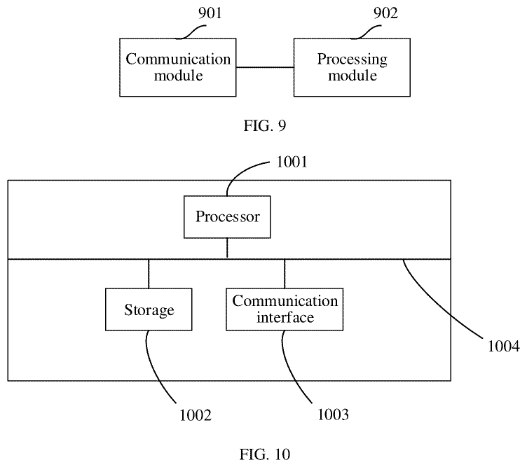

Based on a same technical conception, an embodiment of this application further provides a communication device. The communication device includes a processor 1001 shown in FIG. 10, and the processor 1001 is coupled to a storage 1002. Further, the communication device may further include a communication interface 1003 and a communication bus 1004.

The processor 1001 may be a general-purpose processor, a microprocessor, an application-specific integrated circuit (ASIC), a field programmable gate array (FPGA) or another programmable logic device, a discrete gate or a transistor logic device, or one or more integrated circuits configured to control program execution of the solutions in this application. The general-purpose processor may be a microprocessor, any conventional processor, or the like. The steps of the method disclosed with reference to embodiments of this application may be directly performed and completed by a hardware processor, or may be performed and completed by using a combination of a hardware module and a software module in the processor.

The storage 1002 is configured to: store program instructions and/or data, to cause the processor 1001 to invoke the instructions and/or the data stored in the storage 1002, and implement the foregoing functions of the processor 1001. The storage 1002 may be a read-only memory (ROM) or another type of static storage device capable of storing static information and instructions, a random access memory (RAM) or another type of dynamic storage device capable of storing information and instructions, or may be an electrically erasable programmable read-only memory (EEPROM) or any other medium that can be used to carry or store expected program code in a form of instructions or a data structure and that is accessible by a computer, but is not limited thereto. The storage 1002 may exist independently, for example, an off-chip storage, and is connected to the processor 1001 through the communication bus 1004. Alternatively, the storage 1002 may be integrated with the processor 1001.

The communication interface 1003 uses any apparatus like a transceiver, and is configured to communicate with another device or a communication network, for example, Ethernet, a radio access network (RAN), or a wireless local area network (WLAN). In embodiments of this application, the processor 1001 is configured to: invoke the communication interface 1003 to perform a receiving and/or sending function, and perform the method according to any one of the foregoing possible implementations.

The communication bus 1004 may include a path for transferring information between the foregoing components.

The communication device may be a first control node, a first charging node, or a first execution node.

When the communication device is the first control node, the processor 1001 may perform the following steps through the communication interface 1003: receiving a first request, where the first request is for requesting to allocate a resource; obtaining a charging policy and charging information, where the charging policy includes a charging policy corresponding to at least one charging type, the charging information includes charging information corresponding to the at least one charging type, and the charging type includes one or more of the following types: a functional type, a value type, a resource type, and a scenario-based type; and sending a charging rule to at least one execution node, where the charging rule includes the charging policy and the charging information, or the charging rule is generated based on the charging policy and the charging information, to cause the at least one execution node to report resource utilization information according to the charging rule, and the at least one execution node is an execution node that is configured to provide a resource and that is allocated by the first control node.

In addition, the foregoing components may be further configured to support another process performed by the first control node in the embodiments shown in FIG. 4 to FIG. 8b. For beneficial effects, refer to the foregoing descriptions. Details are not described herein again.

When the communication device is the first charging node, the processor 1001 may perform the following steps through the communication interface 1003: sending charging information to a first control node, to cause the first control node to send the charging information to at least one first execution node, where the charging information includes charging information corresponding to at least one charging type, and the charging type includes one or more of the following types: a service type, a value type, a resource type, and a scenario-based type; and receiving first resource utilization information that is reported based on the charging information.

In addition, the foregoing components may be further configured to support another process performed by the first charging node in the embodiments shown in FIG. 4 to FIG. 8b. For beneficial effects, refer to the foregoing descriptions. Details are not described herein again.

When the communication device is the first execution node, the processor 1001 may perform the following step through the communication interface 1003: receiving a charging rule sent by a first control node, where the charging rule includes a charging policy and charging information, or the charging rule is generated based on a charging policy and charging information, the charging policy includes a charging policy corresponding to at least one charging type, the charging information includes charging information corresponding to the at least one charging type, and the charging type includes one or more of the following types: a functional type, a value type, a resource type, and a scenario-based type; and reporting resource utilization information according to the charging rule.

In addition, the foregoing components may be further configured to support another process performed by the first execution node in the embodiments shown in FIG. 4 to FIG. 8b. For beneficial effects, refer to the foregoing descriptions. Details are not described herein again.

Based on a same technical concept, an embodiment of this application further provides a computer-readable storage medium. The computer-readable storage medium stores computer-readable instructions. When the computer-readable instructions are run on a computer, the method according to any one of the foregoing possible implementations is performed.

An embodiment of this application provides a computer program product including instructions, and when the computer program product runs on a computer, the foregoing method embodiments are performed.

An embodiment of this application provides a chip, including a processor. The processor is coupled to a storage, and the storage is configured to store instructions. When the instructions are executed by the processor, the chip is caused to implement the method steps performed by any one of the foregoing nodes.

In descriptions about embodiments of this application, “and/or” describes an association relationship between associated objects, and indicates that three relationships may exist. For example, A and/or B may indicate the following three cases: Only A exists, both A and B exist, and only B exists. “A plurality of” in this application means two or more.

In addition, it should be understood that in descriptions of this application, terms such as “first” and “second” are merely used for distinguishing and description, and shall not be understood as an indication or implication of relative importance, and shall not be understood as indication or implication of a sequence. Reference to “an embodiment”, “some embodiments”, or the like described in this specification means that a feature, structure, or characteristic described with reference to the embodiment is included in one or more embodiments of this application. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. Terms “include”, “have”, and their variants all mean “include but are not limited to”, unless otherwise specifically emphasized in another manner.

The method steps in embodiments of this application may be implemented by hardware, or may be implemented by executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or a storage medium in any other form well-known in the art. For example, a storage medium is coupled to the processor, so that the processor can read information from the storage medium and write information into the storage medium. Certainly, the storage medium may alternatively be a component of the processor. The processor and the storage medium may be located in an ASIC. In addition, the ASIC may be located in a base station or a terminal. Certainly, the processor and the storage medium may alternatively exist in the base station or the terminal as discrete components.

All or some of the foregoing embodiments may be implemented by using software, hardware, firmware, or any combination thereof. When software is used for implementation, all or some of embodiments may be implemented in a form of a computer program product. The computer program product includes one or more computer programs or instructions. When the computer programs or the instructions are loaded and executed on a computer, all or some of the procedures or functions according to embodiments of this application are performed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium accessible by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise specified or logically conflicted, terms and/or descriptions in different embodiments are consistent and may be mutually referenced, and technical features in different embodiments may be combined based on an internal logical relationship thereof, to form a new embodiment.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. A charging method, wherein the method comprises:
receiving, by a first control node, a first request, wherein the first request is for requesting to allocate a resource;
obtaining, by the first control node, a charging policy and charging information, wherein the charging policy comprises a charging policy corresponding to at least one charging type, the charging information comprises charging information corresponding to the at least one charging type, and the charging type comprises one or more of the following types: a functional type, a value type, a resource type, or a scenario-based type; and
sending, by the first control node, a charging rule to at least one execution node, wherein the charging rule comprises the charging policy and the charging information, or the charging rule is generated based on the charging policy and the charging information, to cause the at least one execution node to report resource utilization information according to the charging rule, and the at least one execution node is an execution node that is configured to provide a resource and that is allocated by the first control node.

2. The method according to claim 1, wherein the method further comprises:
sending, by the first control node, the charging rule to a second control node, wherein the first control node is a control node in a first charging domain, and the second control node is a control node in a second charging domain.

3. The method according to claim 1, wherein the method further comprises:
sending, by the first control node, indication information to a first execution node, wherein the first execution node is an execution node that is in a first charging domain and that is of the at least one execution node, and the indication information indicates the first execution node to send the charging policy and the charging information to a second execution node in a second charging domain.

4. The method according to claim 1, wherein the obtaining, by the first control node, the charging policy and the charging information comprises:
obtaining, by the first control node, the charging policy from a first policy node, and obtaining, by the first control node, the charging information from a first charging node; or obtaining, by the first control node, the charging policy and the charging information from a first charging node.

5. The method according to claim 4, wherein the obtaining, by the first control node, the charging policy from the first policy node comprises:
sending, by the first control node, a charging policy request to the first policy node, wherein the charging policy request comprises charging type information; and
receiving, by the first control node, the charging policy sent by the first policy node, wherein the charging policy is a charging policy corresponding to the charging type information.

6. The method according to claim 4, wherein the obtaining, by the first control node, the charging information from the first charging node comprises:
sending, by the first control node, a charging request to the first charging node, wherein the charging request comprises one or more of the following charging configuration information: a charging type, charging manner information, and charging granularity information; and
receiving, by the first control node, charging information that corresponds to the charging configuration information and that is sent by the first charging node.

7. The method according to claim 6, wherein the charging request further comprises charging scenario information, and the charging scenario information comprises at least one of the following:
a scenario-based identifier for charging, a scenario-based parameter, a sub-scenario-based identifier for charging, and a sub-scenario-based parameter; and
the charging information corresponds to the charging scenario information.

8. The method according to claim 1, wherein the sending, by the first control node, the charging rule to the at least one execution node comprises:
sending, by the first control node, the charging rule to each of the at least one execution node; or
sending, by the first control node, the charging rule to a target execution node in the at least one execution node, to cause the target execution node to send the charging rule to an execution node other than the target execution node in the at least one execution node.

9. The method according to claim 1, wherein the method further comprises:
receiving, by the first control node, resource utilization information that is of a requesting node and that is sent by the at least one execution node; and
sending, by the first control node, the resource utilization information to the first charging node, wherein the first charging node is a charging node in a charging domain in which the first control node is located.

10. The method according to claim 1, wherein the method further comprises:
receiving, by the first control node, resource utilization information that is of a requesting node and that is sent by the at least one execution node; and
sending, by the first control node, the resource utilization information to a second charging node or a settlement node in the second charging domain, wherein the first control node is a control node in the first charging domain.

11. The method according to claim 1, wherein
the functional type comprises one or more of the following types: traffic, duration, and an event; or
the value type comprises one or more of the following types: a rate, a latency, slice assurance, and content; or
the resource type comprises one or more of the following types: a computing resource, a storage resource, a network resource, and a model resource; or
the scenario-based type comprises one or more of the following types: a positioning scenario, a game acceleration scenario, and a video decoding scenario.

12. A charging method, wherein the method comprises:
sending, by a first charging node, charging information to a first control node, to cause the first control node to send the charging information to at least one first execution node, wherein the charging information comprises charging information corresponding to at least one charging type, and the charging type comprises one or more of the following types: a service type, a value type, a resource type, and a scenario-based type; and
receiving, by the first charging node, first resource utilization information that is reported based on the charging information.

13. The method according to claim 12, wherein the method further comprises:
sending, by the first charging node, the first resource utilization information to a second charging node, wherein the first charging node is a charging node in a first charging domain, and the second charging node is a charging node in a second charging domain.

14. The method according to claim 12, wherein the method further comprises:
receiving, by the first charging node, third resource utilization information sent by a third control node or a third execution node, wherein the third control node is a control node in a third charging domain, and the third execution node is an execution node in the third charging domain.

15. The method according to claim 12, wherein the method further comprises:
obtaining, by the first charging node, a charging policy from a first policy node, wherein the charging policy comprises a charging policy corresponding to the at least one charging type; and
the sending, by the first charging node, the charging information to the first control node comprises:
sending, by the first charging node, the charging policy and the charging information to the first control node.

16. A communication apparatus, comprising a processor, the processor is configured to, when executing the programming instructions, enable the communication apparatus to: receiving a first request, wherein the first request is for requesting to allocate a resource;
obtaining a charging policy and charging information, wherein the charging policy comprises a charging policy corresponding to at least one charging type, the charging information comprises charging information corresponding to the at least one charging type, and the charging type comprises one or more of the following types: a functional type, a value type, a resource type, or a scenario-based type; and
sending a charging rule to at least one execution node, wherein the charging rule comprises the charging policy and the charging information, or the charging rule is generated based on the charging policy and the charging information, to cause the at least one execution node to report resource utilization information according to the charging rule, and the at least one execution node is an execution node that is configured to provide a resource and that is allocated by the communication apparatus.

17. The apparatus according to claim 16, wherein the processor further enable the communication apparatus to:
sending the charging rule to a second control node, wherein the communication apparatus is a control node in a first charging domain, and the second control node is a control node in a second charging domain.

18. The apparatus according to claim 16, wherein the processor further enable the communication apparatus to:
sending indication information to a first execution node, wherein the first execution node is an execution node that is in a first charging domain and that is of the at least one execution node, and the indication information indicates the first execution node to send the charging policy and the charging information to a second execution node in a second charging domain.

19. The apparatus according to claim 16, wherein the obtaining the charging policy and the charging information comprises:
obtaining the charging policy from a first policy node, and obtaining the charging information from a first charging node; or
obtaining the charging policy and the charging information from a first charging node.

20. The apparatus according to claim 19, wherein the obtaining the charging policy from the first policy node comprises:
sending a charging policy request to the first policy node, wherein the charging policy request comprises charging type information; and
receiving the charging policy sent by the first policy node, wherein the charging policy is a charging policy corresponding to the charging type information.
